(19) United States
(12) Patent Application Publication
(10) Pub. No.: US 2026/0301288 A1
(43) Pub. Date: Oct. 1, 2026

(54) CHARACTER ANIMATION USING NEURAL RENDERING WITH ATTENTION MASKS

(71) Applicant: NVIDIA Corporation, Santa Clara, CA (US)

(72) Inventors: Zhengyu Huang, Zhejiang (CN); Rui Zhang, Beijing (CN); Yu Chen, Shanghai (CN); Tao Li, Beijing (CN); Yingying Zhong, Shanghai (CN); Muyang Du, Shanghai (CN); Jingqi Zhang, Beijing (CN); Yuekai Zhang, Shanghai (CN); Weihua Zhang, Beijing (CN); Junjie Lai, Beijing (CN)

(21) Appl. No.: 19/174,649

(22) Filed: Apr. 9, 2025

(30) Foreign Application Priority Data
Mar. 27, 2025 (CN) 2025103735633

(51) Int. Cl. G06T 13/40; G06F 3/01; G06T 7/90; G06T 17/00

(52) U.S. Cl. CPC G06T 13/40; G06F 3/013; G06T 7/90; G06T 17/00

(57) ABSTRACT

In various examples, techniques for neural rendering of characters using attention masks are described herein. Systems and methods described herein may use various techniques with regard to neural rendering (and/or any other rendering techniques) to render smooth, stable, and/or quality interactive characters. For instance, in some examples, an attention mask may be used to stabilize the motion outside of a specific region of a character-such as a mouth region of the character-that may be caused by audio inputs processed using one or more neural networks. Additionally, in some examples, an attention mask may be used to stabilize motion outside of other specific regions of the character-such as eye regions of the character-that may be caused by eye movement inputs processed using the neural network(s). As such, the masks may be used to control the motion that is caused by the different inputs.

### CROSS-REFERENCE TO RELATED APPLICATIONS

This application claims priority from Chinese Application No. 2025103735633, filed Mar. 27, 2025, which is hereby incorporated by reference in its entirety.

### BACKGROUND

Interactive characters—such as avatars—are used in a wide variety of applications to interact with users through speech. Different technologies have been developed to render these characters—such as by using neural rendering, three-dimensional models, and/or the like. Neural rendering is a technique in computer graphics that uses neural networks and/or deep learning algorithms to generate images of interactive characters. For example, the neural networks may be trained using real-world data—such as image data representing images depicting a real-world person that corresponds to an interactive character—in different poses and/or while performing various actions (e.g., speaking). During the training using the real-world data, the neural networks may then learn how light interacts with the character when in different poses and/or while speaking. This way, after training, the neural networks may be used to render images of the character interacting with users.

However, current neural rendering systems—such as those implementing Neural Radiance Fields (NeRFs)—may experience problems when rendering characters that are interacting with users. For example, neural rendering systems may render characters that are unstable, where the heads of the characters jitter with the movements of the characters. While some techniques have been developed to try and stabilize the characters—such as by adding a learnable audio-attention module that encourages the audio to only affect specific regions around the mouths of the characters—these techniques still experience problems. For example, even with learned attention, the input audio can still affect regions of the characters that are outside of the mouth regions, where these other regions should not be affected by the characters speaking.

### SUMMARY

Embodiments of the present disclosure relate to techniques for neural rendering of characters using attention masks and/or operating states. Systems and methods described herein may use various techniques with regard to neural rendering (and/or any other rendering techniques) to render smooth, stable, and/or quality interactive characters. For instance, in some examples, one or more attention masks may be used to stabilize the motion outside of a specific region of a character—such as a mouth region of the character—that may be caused by audio inputs processed using one or more neural networks. Additionally, in some examples, one or more additional masks may be used to stabilize motion outside of other specific regions of the character—such as eye regions of the character—that may be caused by eye movement inputs processed using the neural network(s). Furthermore, in some examples, mechanisms may be used to smoothly transition a character between different operating states, such as an idle state where the character is not interacting, a transition state where the character is preparing to interact, and an interactive state where the character is interacting. For instance, the mechanisms may ensure that poses and/or mouth movements of the character remain smooth between the operating states.

In contrast to conventional systems, the systems of the present disclosure, in some embodiments, use the mask(s) to limit the motion of characters that may be caused by various inputs-such as audio inputs and/or eye movement inputs-to affect specific regions of the characters-such as the mouth regions and/or the eye regions-without affecting other regions of the characters. For example, even though the audio-attention modules of the conventional systems may encourage audio to only affect the mouth regions of the characters, the learned attention may not be perfect such that other regions may still be affected by the audio inputs. As such, the systems of the present disclosure may use the masks to eliminate and/or reduce the motion in these other regions that would be caused by the audio inputs.

Additionally, in contrast to the conventional systems, the systems of the present disclosure, in some embodiments, may operate the presentation of the characters using the different operating states, where the poses of the characters are maintained even when switching between different operating states. This may also improve the quality of the rendering as compared to conventional techniques by ensuring that the characters are stable during the presentation. Additionally, and as described in more detail herein, the systems of the present disclosure may use a recorded video of a character for one or more operating states, such as the idle state and/or the transition state, while generating new frames of the character for one or more other operating states, such as the interactive state. This may also provide improvements over the conventional techniques, such as by reducing the amount of computing resources needed to present characters.

### BRIEF DESCRIPTION OF THE DRAWINGS

The present systems and methods for techniques for neural rendering of characters using attention masks and/or operating states are described in detail below with reference to the attached drawing figures, wherein:

FIG. 1 illustrates an example data flow diagram for a process of using a neural rendering system to render content associated with an interactive character, in accordance with some embodiments of the present disclosure;

FIG. 2 illustrates an example data flow diagram for a process of using one or more language components to process user speech, in accordance with some embodiments of the present disclosure;

FIGS. 3A-3B illustrate examples of regions associated with attention masks used for rendering a character, in accordance with some embodiments of the present disclosure;

FIG. 4 illustrates an example of one or more neural networks that use attention masks to perform neural rendering associated with characters, in accordance with some embodiments of the present disclosure;

FIG. 5 illustrates an example of a recorded video that may be presented during an idle state associated with a presentation of a character, in accordance with some embodiments of the present disclosure;

FIG. 6A illustrates an example of transitioning from operating in an idle state to an interactive state when presenting a character, in accordance with some embodiments of the present disclosure;

FIG. 6B illustrates an example of transitioning from operating in an interactive state to an idle state when presenting a character, in accordance with some embodiments of the present disclosure;

FIG. 7 illustrates an example data flow diagram for a process of training one or more neural networks to perform neural rendering of a character, in accordance with some embodiments of the present disclosure;

FIG. 8 illustrates an example of one or more systems that may use one or more of the processes described herein to render and provide a character, in accordance with some embodiments of the present disclosure;

FIGS. 9-10 illustrate flow diagrams showing methods for performing neural rendering using one or more attention masks, in accordance with some embodiments of the present disclosure;

FIGS. 11-12 illustrate flow diagrams showing methods for controlling a presentation of a character using various operating states, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

Systems and methods are disclosed for techniques for neural rendering of characters using attention masks and/or operating states. For instance, a system(s) may use one or more neural networks that are associated with performing one or more tasks—such as neural rendering —to render frames of a character interacting with users. As described herein, the neural network(s) may include and/or be associated with a Neural Radiance Field (NeRF), Gaussian splatting, Plenoxels, neural control variates, and/or any other type of neural rendering technique. For instance, the system(s) may input data into the neural network(s)—such as pose data representing a pose (e.g., three-dimensional points) of a character, audio data representing speech to be output by the character, and/or eye data representing one or more values for controlling the eyes of the character—into the neural network(s). The neural network(s) may then process the input data and generate output data representing densities and/or colors associated with points corresponding at least to the character. The system may then use the output data to generate frames representing the character.

In some examples, the neural network(s) may include and/or use one or more components to improve the quality of the rendering. For instance, the neural network(s) may include at least an audio-attention module that is trained to cause the audio input to affect one or more specific regions of the character—such as one or more mouth regions—without affecting one or more other regions of the character. For example, the audio-attention module may cause the audio input to have a greater impact on values of points that are associated with the mouth region(s) rather than values of points associated with the other region(s) of the character, where the values (e.g., weights) of the points may be associated how the audio input affects the motion of the character. In some examples, the audio-attention module may be configured to perform such actions since the audio should affect the motion around the mouth of the character more than the motion around other portions of the head of the character. For example, the values of the points that are associated with the mouth region(s) should be greater than the values of the points associated with the other region(s) since the audio input should cause more motion with regard to the mouth region(s) as compared to the other region(s).

However, and as described herein, the learned attention associated with the audio-attention module may not be perfect. As such, the system(s) and/or the neural network(s) may include and/or use one or more additional components to set which regions of the character are affected by the audio input. For instance, the neural network(s) may use and/or include a first attention mask, which may also be referred to as the “audio-attention mask,” that is configured to update values of the points determined using the audio-attention module. For instance, the audio-attention mask may be applied to the values of the points in order to cause the values of the points that are associated with the mouth region(s) of the character to remain constant and/or substantially constant while causing the values of the points that are associated with the other region(s) of the character to reduce and/or be zero. By using the audio-attention mask, the system(s) and/or the neural network(s) may ensure that the audio input affects the motion of the mouth region(s) more than the other region(s) and/or ensure that the other region(s) is not affected by the audio input since the values of the points within the other region(s) may be reduced to zero.

In some examples, the audio-attention mask may be associated with multiple regions corresponding to the head of the character. For example, the mouth region(s) may be associated with at least the mouth, at least a portion of the cheeks, the nose, the chin, and/or any other feature of the head of the character that should include motion when the character is speaking. Additionally, the other region(s) may be associated with a remainder of the features of the head that should not include motion when the character is speaking. In some examples, the mouth region(s) may then be associated with a first value (e.g., a first weight) that causes little or no change in the values of points while the other region(s) may be associated with a second value (e.g., a second weight) that causes a decrease and/or zeroing of the values of points.

As described herein, in some examples, another input to the neural network(s) may include the eye data representing the value(s) for controlling the eye movements of the character. For instance, the eye values may be associated with a range between 0 and 1 (and/or any other range), where an eye value of 0 (e.g., the minimum value) may be associated with the character closing the eyes, an eye value of 1 (e.g., the maximum value) may be associated with the character completely opening the eyes, and eye values between 0 and 1 may be associated with the character partially opening the eyes. As such, the neural network(s) (e.g., an eye-attention module) may be trained to cause the eye input to affect one or more specific regions of the character-such as one or more eye regions-without affecting one or more other regions of the character. For example, the neural network(s) may cause the eye input to have a greater impact on values of points that are associated with the eye region(s) rather than values of points associated with the other region(s) of the character, where the values (e.g., weights) of the points may again be associated how the eye input affects the motion of the character.

However, and as described herein, the learned attention associated with the eye-attention module may also not be perfect. As such, the system(s) and/or the neural network(s) may include and/or use one or more additional components to set which regions of the character are affected by the eye input. For instance, the neural network(s) may use and/or include a second attention mask, which may also be referred to as the “eye-attention mask,” that is configured to update values of the points determined using the eye-attention module. For instance, the eye-attention mask may be applied to the values of the points in order to cause the values of the points that are associated with the eye region(s) of the character to remain constant and/or substantially constant while causing the values of the points that are associated with the other region(s) of the character to reduce and/or be zero. By using the eye-attention mask, the system(s) and/or the neural network(s) may ensure that the eye input affects the motion of the eye region(s) more than the other region(s) and/or ensure that the other region(s) is not affected by the eye input since the values of the points within the other region(s) may be reduced to zero.

In some examples, the eye-attention mask may be associated with multiple regions corresponding to the head of the character. For example, the eye region(s) may be associated with at least the eyes, one or more portions of the face that at least partially surround the eyes, and/or any other feature of the head of the character that should include motion when the character is blinking. Additionally, the other region(s) may be associated with a remainder of the features of the head that should not include motion when the character is blinking. In some examples, the eye region(s) may then be associated with a first value (e.g., a first weight) that causes little or no change in the values of points while the other region(s) may be associated with a second value (e.g., a second weight) that causes a decrease and/or zeroing of values of points.

In some examples, the system(s) may cause the character to operate in various operating states. For example, the operating states may include at least a first state (referred to as the “idle state”) where the character is not interacting with users (e.g., the character is not speaking to the users), a second state (referred to as the “transition state”) where the character is getting ready to interact with users (e.g., audio representing speech for the character is received), and a third state (referred to as the “interactive state”) where the character is interacting with the users (e.g., the character is animated as speaking). In some examples, the system(s) may use the neural network(s) to continue rendering frames of the character when operating in the any of the operating states. However, in some examples, such as improve the performance of the system(s) (e.g., reduce the amount of computing resources required to perform the neural rendering), the system(s) may only use the neural network(s) to render frames for the character when operating in one or more specific operating states.

For instance, the system(s) may use the neural network(s) to generate a recorded video that is associated with a given length of time (e.g., 10 seconds). When generating the recorded video, the system(s) may input audio data that represents little or no speech such that the recorded video represents the character not interacting with users. Additionally, the frames of the recorded video may be associated with different poses associated with at least a portion of the character, such as the locations and/or orientations of the head of the character. While in the idle state, the system(s) may then cause a presentation of the recorded video, where the recorded video plays in a forward direction until reaching the end, plays in a reverse direction until reaching the beginning again, plays in the forward direction until again reaching the end, and then continues this playback process. Additionally, the system(s) may cause the playback of the recorded video until the occurrence of one or more events, such as audio data associated with speech for the character being received and/or generated.

For instance, based on the audio data, the system(s) may transition the presentation of the character to the transition state. In the transition state, the system(s) may continue to present the playback of the recorded video for a period of time before transitioning to the interactive state, but also begin to generate new frames that represent the character speaking. Additionally, in order to ensure a smooth transition between the transition state and the interactive state, the system(s) may determine specific poses associated with the character for generating the new frames. For example, the system(s) may determine a next frame of the recorded video that would be presented after the period of time elapses to make the transition to the interactive state and determine the pose associated with the next frame and/or one or more additional poses associated with one or more subsequent frames. The system(s) may then use these identified poses to generate the new frames that represent the character speaking.

For instance, the system(s) may input data into the neural network(s), where the input data represents the audio data, pose data representing the poses, and/or eye data representing eye movements associated with the character. Based at least on the neural network(s) processing the input data, the system(s) may generate image data representing the new frames depicting the character speaking. As such, when transitioning from the transition state to the interactive state, the system(s) may then cause presentation of the new frames such that the poses of the character remain smooth when the transition occurs. In some examples, this process may continue to repeat while operating in the interactive state, such as to continue generating new frames representing the character speaking.

The system(s) may then transition from operating in the interactive state to again operating in the idle state, such as after the character is finished speaking. As such, the system(s) may again present the playback of the recorded video. In some examples, such as to again ensure a smooth transition between the interactive state and the idle state, the system(s) may determine which frame of the recorded video to begin with when making the transition to the idle state, such as a frame that is subsequent to the last frame from the recorded video that is associated with the last pose used to generate a new frame. The system(s) may then continue to perform these processes of transitioning between the operating states while users interact with the character. By performing such features, the system(s) may ensure the smooth transitions between the operating states, such that the pose of the character is accurate and/or not jittery during the transitions, without needing to constantly use the neural network(s) to render new frames of the character.

While the examples herein are directed to using the neural network(s) during inference to render frames of the character, in some examples, one or more similar processes may be used to train the neural network(s) to perform neural rendering. For example, the system(s) (and/or another system) may obtain training data for training the neural network(s). In some examples, the training data may include image data representing a video of a real-world person that corresponds to the character, pose data representing poses of the real-world person within the video, and/or eye data representing eye movements of the real-world person within the video. The system(s) may then use one or more techniques to train the neural network(s) using the training data. Additionally, in some examples, such as to improve the performance of the training and/or the neural network(s), the system(s) and/or the neural network(s) may include and/or use at least one or more of the masks during the training. The training of the neural network(s) is described in more detail herein.

In some examples, the mode(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples —such as where the model(s) is large-the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

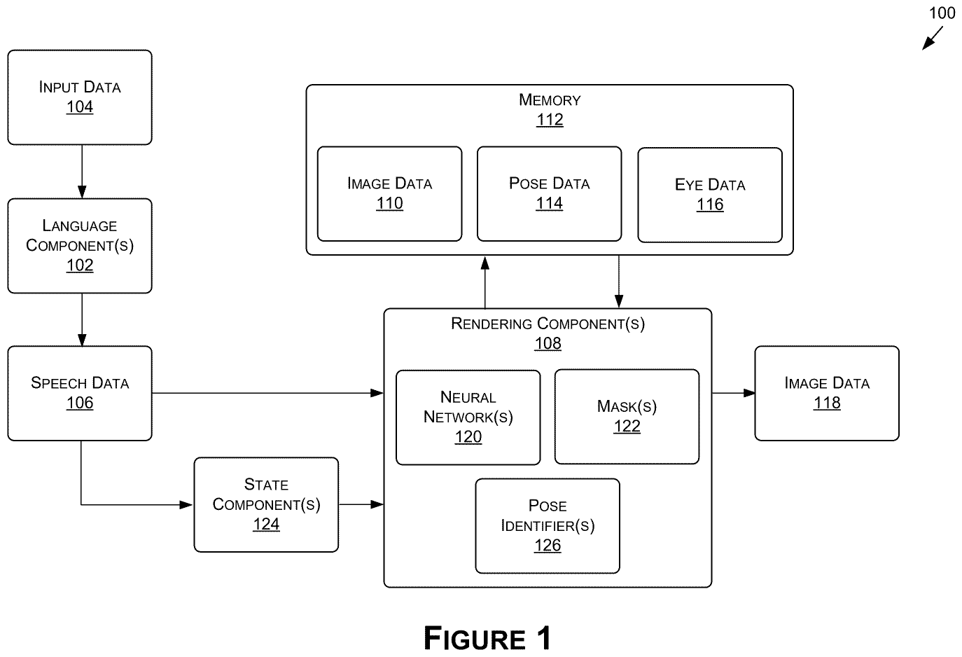

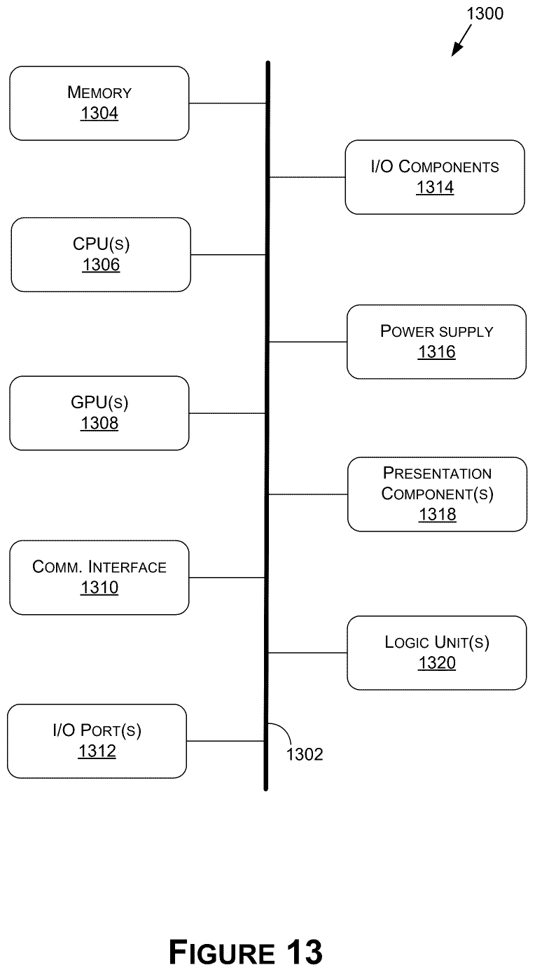

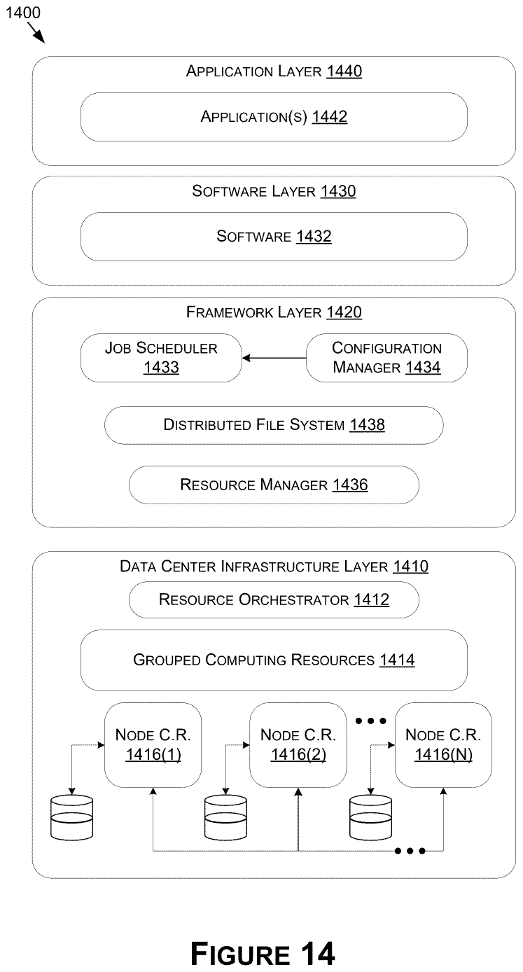

With reference to FIG. 1, FIG. 1 illustrates an example data flow diagram for a process 100 of using a neural rendering system to render content associated with an interactive character, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle @100 of FIGs. @1A-@1D, example computing device 1300 of FIG. 13, and/or example data center 1400 of FIG. 14.

For instance, the process 100 may include one or more language components 102 receiving input data 104 representing an interaction from a user. As described herein, the input data 104 may include, but is not limited to, audio data representing the user speech, text data representing text, input data representing one or more user inputs, and/or any other type of input data. Additionally, the interaction may include, but is not limited to, a query, a question, a request, a statement, a command, and/or any other type of interaction that may be provided by the user. The process 100 may then include the language component(s) 102 processing the input data 104 in order to generate speech data 106 associated with speech that is to be output by the character. As described herein, the speech data 106 may include, but is not limited to, audio data representing the speech, text data representing text corresponding to the speech, and/or any other type of data.

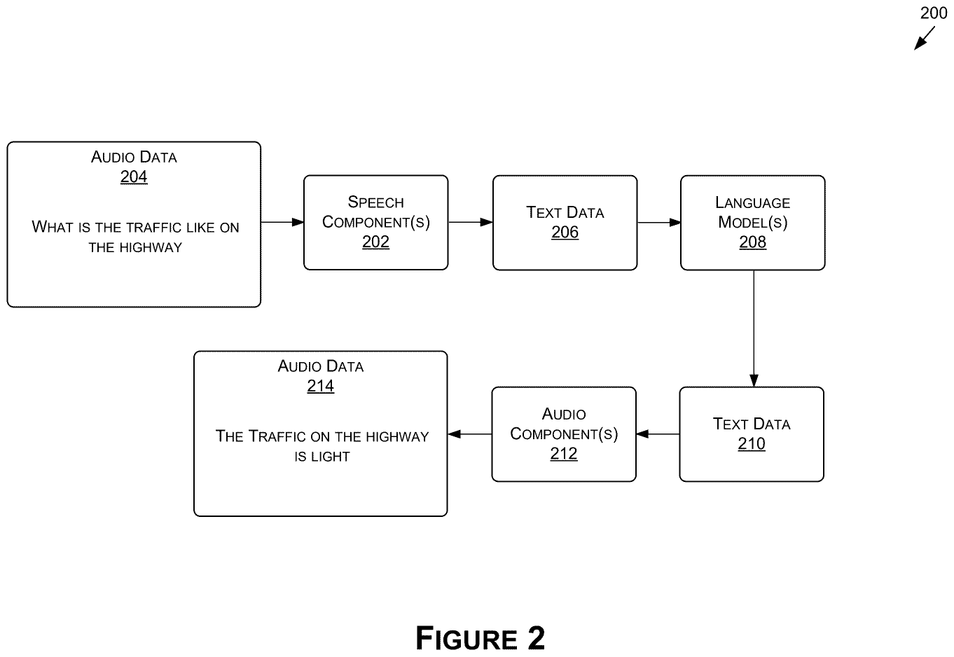

For more details, FIG. 2 illustrates an example data flow diagram for a process 200 of using the language component(s) 102 to process user speech, in accordance with some embodiments of the present disclosure. As shown, the process 200 may include one or more speech components 202 (which may include and/or be part of the language component(s) 102) processing audio data 204 representing speech to generate text data 206 representing text associated with the speech. In some examples, the speech component(s) 202 may include and/or use a voice activity detection (VAD) component to detect the speech represented by the audio data 204, an automatic speech recognition (ASR) component to process the speech and generate the text represented by the text data 206, a natural language understanding component, and/or any other type of speech processing component. In the example of FIG. 2, the speech may include a question, such as “What is the traffic like on the highway.” As such, the text represented by the text data 206 may include words, tokens, vectors, and/or the like representing the question.

The process 200 may then include one or more language models 208 (which may include and/or be part of the language component(s) 102) processing the text data 206 to generate additional text data 210 representing a response to the question. As described herein, the language model(s) 208 may include any type of language model that is configured to performed one or more of the processes described herein, such as a large language model. The process 200 may then include one or more audio components 212 (which may include and/or be part of the language component(s) 102) processing the text data 210 to generate audio data 214 representing speech associated with the response to the question. In some examples, the audio component(s) 212 may include and/or use a text-to-speech (TTS) component to convert the text represented by the text data 210 to the spoken audio represented by the audio data 214. In the example of FIG. 2, the response may include “The traffic on the highway is light.”

Referring back to the example of FIG. 1, the process 100 may include using one or more rendering components 108 to process input data that includes at least a portion of the speech data 106, at least a portion of image data 110 stored in a memory 112, at least a portion of pose data 114 stored in the memory 112, and/or at least a portion of eye data 116 stored in the memory 112. Based at least on the processing, the process 100 may include the rendering component(s) 108 generating and/or outputting image data 118 representing frames depicting the character. As described herein, in some examples, the rendering component(s) 108 may perform one or more techniques to render the frames represented by the image data 118, such as neural rendering (and/or any other technique). For example, the rendering component(s) 108 may use one or more neural networks 120 to perform at least a portion of the processing, where the neural network(s) 120 may include and/or be associated with NeRF, Gaussian splatting, Plenoxels, neural control variates, and/or any other type of neural rendering technique. For instance, the rendering component(s) 108 may use the neural network(s) 120 to process the input data in order to determine densities and/or color values associated with points corresponding to the character when rendering the frames. The rendering component(s) 108 may then use the color values and/or densities to generate the frames representing the character.

As described herein, the neural network(s) 120 may include and/or use one or more components to improve the quality of the rendering. For instance, the neural network(s) 120 may include at least an audio-attention module that is trained to cause the audio input to affect one or more specific regions of the character—such as one or more mouth regions—without affecting one or more other regions of the character. For example, the audio-attention module may cause the audio input to have a greater impact on values of points that are associated with the mouth region(s) as compared to values of points associated with the other region(s) of the character, where the values (e.g., weights) of the points may be associated how the audio input affects the motion of the character. In some examples, the audio-attention module may be configured to perform such actions since the audio should affect the motion around the mouth of the character more than the motion around other portions of the head of the character. For example, the values of the points that are associated with the mouth region(s) should be greater than the values of the points associated with the other region(s) since the audio input should cause more motion with regard to the mouth region(s) as compared to the other region(s).

In some examples, the neural network(s) 120 may also include and/or use an audio-attention mask 122 that is configured to update values of the points determined using the audio-attention module. For instance, the audio-attention mask 122 may be applied to the values of the points in order to cause the values of the points that are associated with the mouth region(s) of the character to remain constant and/or substantially constant while causing the values of the points that are associated with the other region(s) of the character to reduce and/or be zero. By using the audio-attention mask 122, the rendering component(s) 108 and/or the neural network(s) 120 may ensure that the audio input affects the motion of the mouth region(s) more than the other region(s) and/or ensure that the other region(s) is not affected by the audio input since the values of the points within the other region(s) may be reduced to zero.

In some examples, the neural network(s) 120 may include and/or use an eye-attention mask 122 that is configured to update values of points determined based on the eye data 116. For instance, and as described herein, the eye data 116 may represent eye value(s) for controlling the eye movements of the character. For instance, the eye values may be associated with a range between 0 and 1 (and/or any other range), where an eye value of 0 (e.g., the minimum value) may be associated with the character closing the eyes, an eye value of 1 (e.g., the maximum value) may be associated with the character completely opening the eyes, and eye values between 0 and 1 may be associated with the character partially opening the eyes. As such, the neural network(s) 120 (e.g., an eye-attention module) may be trained to cause the eye input to affect one or more specific regions of the character—such as one or more eye regions—without affecting one or more other regions of the character. For example, the neural network(s) 120 may cause the eye input to have a greater impact on values of points that are associated with the eye region(s) as compared to values of points associated with the other region(s) of the character, where the values (e.g., weights) of the points may be associated how the eye input affects the motion of the character.

The neural network(s) 120 may then use the eye-attention mask 122 to set which regions of the character are affected by the eye input. For instance, the eye-attention mask 122 may be applied to the values of the points determined using the eye-attention module in order to cause the values of the points that are associated with the eye region(s) of the character to remain constant and/or substantially constant while causing the values of the points that are associated with the other region(s) of the character to reduce and/or be zero. By using the eye-attention mask, the system(s) and/or the neural network(s) may ensure that the eye input affects the motion of the eye region(s) more than the other region(s) and/or ensure that the other region(s) is not affected by the eye input since the values of the points within the other region(s) may be reduced to zero.

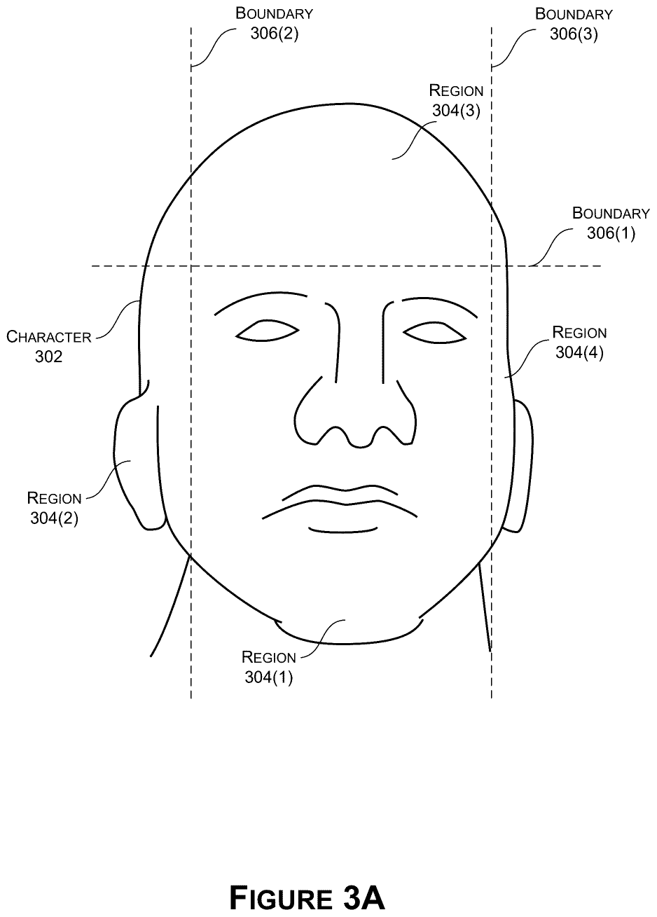

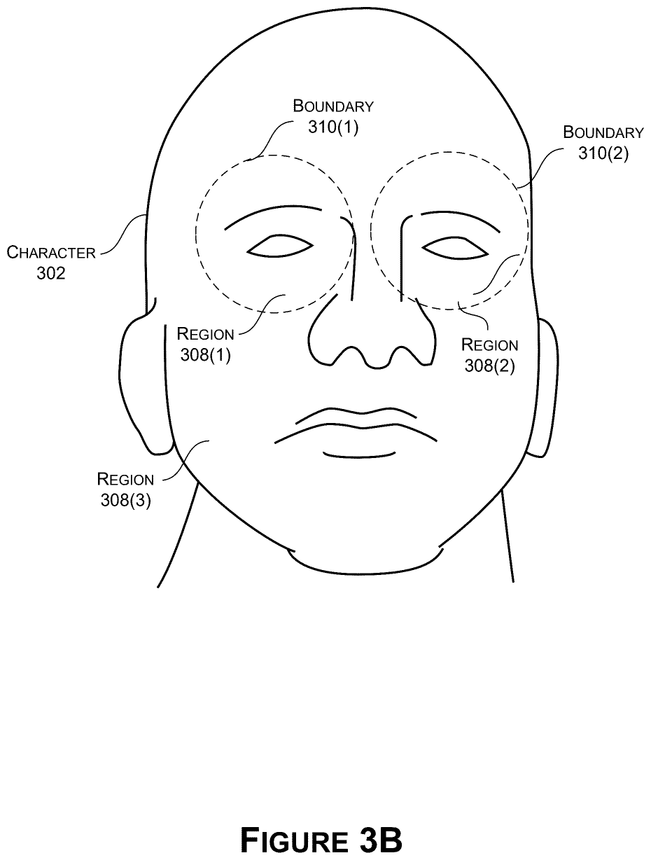

As described herein, the audio-attention mask 122 and/or the eye-attention mask 122 may be generated using various regions of the head of the character. For instance, FIGS. 3A-3B illustrate examples of regions associated with attention masks used for rendering a character 302, in accordance with some embodiments of the present disclosure. As shown by the example of FIG. 3A, the head of the character 302 may be separated into four regions 304(1)-(4) (also referred to singularly as “region 304” or in plural as “regions 304) using three boundaries 306(1)-(3) (also referred to singularly as “boundary 306” or in plural as “boundaries 306”). For instance, the first region 304(1) may be associated with at least the mouth and/or surrounding features of the head of the character 302, the second region 304(2) may be associated with the right side of the head of the character 302 (from the perspective of the character 302), the third region 304(3) may be associated with a top of the head of the character 302, and the fourth region 304(4) may be associated with the left side of the head of the character 302 (from the perspective of the character 302). In some examples, the boundaries 306 may be determined using user input, machine learning, and/or any other technique. While the example of FIG. 3A illustrates using the three boundaries 306 to determine the four region 304 of the character 302, in other examples, any number of boundaries may be used to determine any number of regions of the character 302. Additionally, while the example of FIG. 3A illustrates the boundaries 306 as including straight lines, in other examples, boundaries may include any other line shapes.

The audio-attention mask 122 may then be generated based at least on the regions 304 of the character 302. For example, the audio-attention mask 122 may indicate that values associated with points corresponding to the second region 304(2) should be reduced and/or zero, values associated with points corresponding third region 304(3) should be reduced and/or zero, values associated with points corresponding to the fourth region 304(4) should be reduced and/or zero, and values associated with points corresponding to the first region 304(1) should be unchanged and/or substantially unchanged. In some examples, the audio-attention mask 122 may cause values to be reduced and/or zero using a first weight, such as 0 (and/or any other value), and cause values to remain unchanged and/or substantially unchanged using a second weight, such as 1 (and/or any other value).

As shown by the example of FIG. 3B, the head of the character 302 may now be separated into three region 308(1)-(3) (also referred to singularly as “region 308” or in plural as “regions 308”) using two boundaries 310(1)-(2) (also referred to singularly as “boundary 310” or in plural as “boundaries 310”). For instance, the first region 308(1) may be associated with the right eye of the character 302 (from the perspective of the character 302), the second region 308(2) may be associated with the left eye of the character 302 (from the perspective of the character 302), and the third region 308(3) may be associated with a remaining portion of the head of the character 302. In some examples, the boundaries 310 may be determined using user input, machine learning, and/or any other technique. While the example of FIG. 3B illustrates using the two boundaries 310 to determine the three region 308 of the character 302, in other examples, any number of boundaries may be used to determine any number of regions of the character 302. Additionally, while the example of FIG. 3B illustrates the boundaries 310 as including circles, in other examples, boundaries around the eyes may include any other shape.

The eye-attention mask 122 may then be generated based at least on the regions 308 of the character 302. For example, the eye-attention mask 122 may indicate that values associated with points corresponding to the first region 308(1) should remain unchanged and/or substantially unchanged, values associated with points corresponding to the second region 308(2) should remain unchanged and/or substantially unchanged, and values associated with point corresponding to the third region 308(3) should be reduced and/or zero. In some examples, the eye-attention mask 122 may cause values to be reduced and/or zero using a first weight, such as 0 (and/or any other value), and cause values to remain unchanged and/or substantially unchanged using a second weight, such as 1 (and/or any other value).

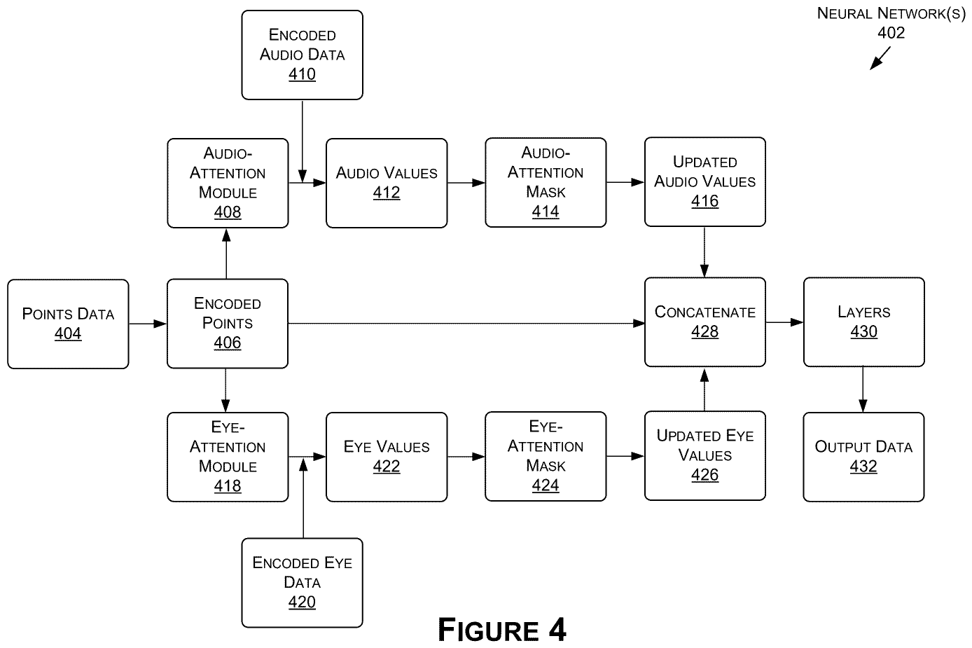

FIG. 4 illustrates an example of one or more neural networks 402 (which may include, and/or be similar to, the neural network(s) 120) that use attention masks to perform neural rendering associated with characters, in accordance with some embodiments of the present disclosure. As show, the neural network(s) 402 may receive points data 404 representing 3D points associated with the character. In some examples, the 3D points may be associated with a specific pose of the character (e.g., a pose represented by the pose data described herein). The neural network(s) 402 may then use one or more encoders (not illustrated) to encode the 3D points in order to generate encoded points 406. In some examples, the encoded points 406 may be associated with features corresponding to the 3D points.

The neural network(s) 402 may then process the encoded points 406 using an audio-attention module 408 to determine initial audio values associated with the 3D points. In some examples, the audio-attention module 408 may include and/or use one or more layers to process the encoded points 406. For example, the audio-attention module 408 may include one or more layers of a multi-layer perceptron (MLP) that is configured to process the encoded points 406. The initial audio values output by the audio-attention module 408 may then be multiplied by encoded audio data 410, which is indicated by the arrows, to generate audio values 412 associated with the 3D points. In some examples, the encoded audio data 410 may be associated with audio features from the audio data representing the speech to be output by the character.

The neural network(s) 402 may then use an audio-attention mask 414 (which may include, and/or be similar to, the audio-attention mask 122) to process the audio values 412 and generate updated audio values 416 associated with the points. As described herein, the audio-attention mask 414 may be applied to the audio values 412 in order to update at least a portion of the audio values 412 associated with the 3D points. For instance, the audio-attention mask 414 may cause the audio values 412 of the 3D points that are associated with the mouth region(s) of the character to remain constant while causing the audio values 412 of the 3D points that are associated with the other region(s) of the character to reduce to zero.

As further illustrated in the example of FIG. 4, the neural network(s) 402 may process the encoded points 406 using an eye-attention module 418 to determine initial eye values associated with the 3D points. In some examples, the eye-attention module 418 may include and/or use one or more layers to process the encoded points 406. For example, the eye-attention module 418 may include one or more layers of a MLP that is configured to process the encoded points 406. The initial eye values output by the eye-attention module 418 may then be multiplied by encoded eye data 420, which is indicated by the arrows, to generate eye values 422 associated with the 3D points. In some examples, the encoded eye data 420 may be associated with eye features corresponding to values for causing the eye movements of the character.

The neural network(s) 402 may then use an eye-attention mask 424 (which may include, and/or be similar to, the eye-attention mask 122) to process the eye values 422 and generate updated eye values 426 associated with the 3D points. As described herein, the eye-attention mask 424 may be applied to the eye values 422 in order to update at least a portion of the eye values 422 associated with the 3D points. For instance, the eye-attention mask 424 may cause the eye values 422 of the 3D points that are associated with the eye regions of the character to remain constant while causing the eye values 422 of the 3D points that are associated with the other region(s) of the character to reduce to zero.

The neural network(s) 402 may then concatenate 428 the encoded points 406 with the updated audio values 416 and the updated eye values 426 and process the concatenated data using one or more layers 430. In some examples, the layer(s) 430 may be associated with one or more layers of a MLP that is configured to process the concatenated data. Based at least on processing the concatenated data, the layer(s) 430 may generate and/or output data 432 associated with the 3D points of the character. For instance, in some examples, the output data 432 may represent densities and/or color values associated with the 3D points. The rendering component(s) 108 may then use the output data 432 to generate the frames representing the character.

Referring back to the example of FIG. 1, the process 100 may include one or more state components 124 determining an operating state associated with presenting the character. As described herein, in some examples, the operating states may include at least an idle state where the character is not interacting with users (e.g., the character is not speaking to the users), a transition state where the character is getting ready to interact with users (e.g., audio representing speech for the character is received), and an interactive state where the character is interacting with the users (e.g., the character is animated as speaking). In some examples, the rendering component(s) 108 may use the neural network(s) 120 to continue rendering frames of the character when operating in any the operating states. However, in some examples, such as to improve the performance of the rendering (e.g., reduce the amount of computing resources required to perform the neural rendering), the rendering component(s) 108 may only use the neural network(s) 120 to render frames of the character when operating in one or more specific operating states.

For instance, the rendering component(s) 108 may use the neural network(s) 120 to generate a recorded video that is associated with a given length of time (e.g., 10 seconds), where the recorded video may be represented by the image data 110. When generating the recorded video, the rendering component(s) 108 may input speech data 106 that is associated with little or no speech such that the recorded video represents the character not interacting with users. Additionally, the frames of the recorded video may be associated with different poses associated with at least a portion of the character—such as the locations and/or orientations of the head of the character—where the poses are represented by the pose data 114. While in the idle state, the rendering component(s) 108 may then cause a presentation of the recorded video, where the recorded video plays in a forward direction until reaching the end, plays in a reverse direction until reaching the beginning again, plays in the forward direction until again reaching the end, and then continues this playback process.

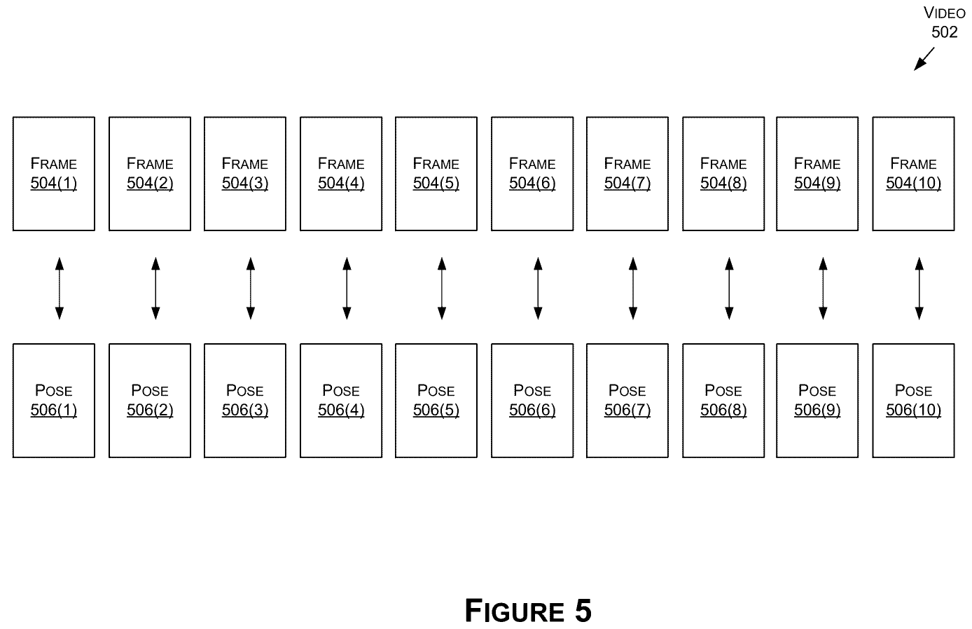

For instance, FIG. 5 illustrates an example of a recorded video 502 that may be presented during an idle state associated with a presentation of a character, in accordance with some embodiments of the present disclosure. As shown, the recorded video 502 may include frames 504(1)-(10) (also referred to singularly as “frame 504” or in plural as “frames 504”) representing a character. In some examples, the frames 504 may represent the character as not interacting with users, such as by not speaking. The frames 504 may also be associated with poses 506(1)-(10) (also referred to singularly as “pose 506” or in plural as “poses 506”) for the character. For example, the first frame 504(1) may represent the character in the first pose 506(1), the second frame 504(2) may represent the character in the second pose 506(2), the third frame 504(3) may represent the character in the third pose 506(3), and/or so forth.

In the idle state, the rendering component(s) 108 may then play the recorded video 502 starting at the first frame 504(1), playing through in the forward direction to the tenth frame 504(10), playing back in the reverse direction to the first frame 504(1), again playing through in the forward direction to the tenth frame 504(10), and/or so forth. This way, the poses 506 of the character remains smooth and/or accurate while presenting the character during the idle state. While the example of FIG. 5 illustrates the recorded video 502 as including the ten frames 504, in other examples, a recorded video may include any number of frames.

Referring back to the example of FIG. 1, the rendering component(s) 108 may cause the playback of the recorded video until the occurrence of one or more events, such as the state component(s) 124 receiving speech data 106 associated with speech for the character. For instance, based at least on receiving the speech data 106, the state component(s) 124 may cause the rendering component(s) 108 to transition the presentation of the character to the transition state. In the transition state, the rendering component(s) 108 may continue to present the playback of the recorded video for a period of time before transitioning the presentation to the interactive state, but also begin to generate new frames that represent the character speaking using one or more of the processes described herein. Additionally, in some examples, the state component(s) 124 may cause the rendering component(s) 108 to transition the presentation to the interactive state after the elapse of the period of time.

As described herein, in order to ensure a smooth transition between the transition state and the interactive state, the rendering component(s) 108 may use one or more pose identifiers 126 to determine specific poses associated with the character for generating the new frames. For example, the pose identifier(s) 126 may determine a next frame of the recorded video that would be presented after the period of time elapses to make the transition to the interactive state and determine the pose associated with the next frame and/or one or more additional poses associated with one or more subsequent frames. The rendering component(s) 108 may then use these identified poses to generate the new frames that represent the character speaking.

For instance, the rendering component(s) 108 may input data into the neural network(s) 120, where the input data represents the speech data 106, pose data representing the poses, and/or eye data 116 representing eye movements associated with the character. Based at least on the neural network(s) 120 processing the input data, the rendering component(s) 108 may generate image data 118 representing the new frames depicting the character speaking, where the image data 118 may initially be stored in the memory 112 while operating in the transition state. As such, when transitioning from the transition state to the interactive state, the rendering component(s) 108 may then use the image data 118 stored in the memory 112 to cause presentation of the new frames such that the poses of the character remain smooth when the transition occurs. In some examples, this process may continue to repeat while operating in the interactive state, such as to continue generating new frames representing the character speaking.

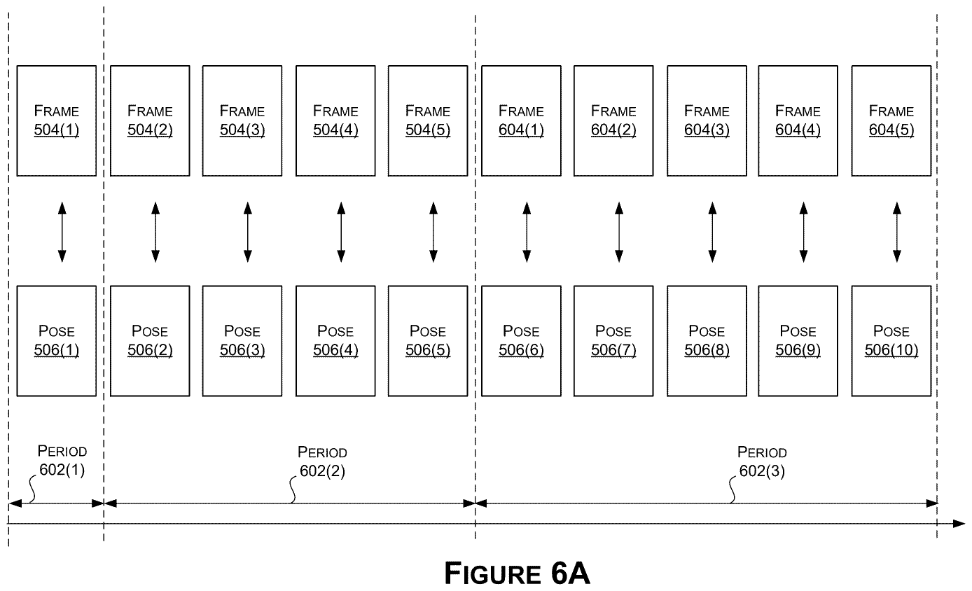

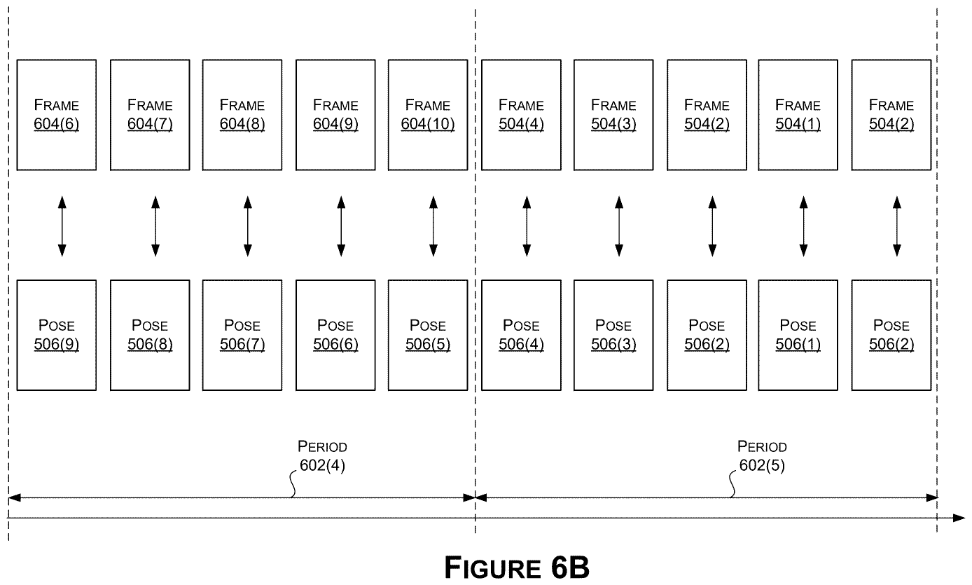

For instance, FIG. 6A illustrates an example of transitioning from operating in an idle state to an interactive state when presenting a character, in accordance with some embodiments of the present disclosure. In the example of FIG. 6A, during a first period of time 602(1), the rendering component(s) 108 may cause the presentation to operate in the idle state. As such, the rendering component(s) 108 may cause the presentation of the first frame 504(1) associated with the recorded video 502. The rendering component(s) 108 may then continue to cause the presentation to operate in the idle state until the occurrence of an event, such as the state component(s) 124 receiving speech data associated with speech for the character.

As such, during a second period of time 602(2), the rendering component(s) 108 may cause the presentation to operate in the transition state. In the transition state, the rendering component(s) 108 may cause the presentation of the frames 504(2)-(5) of the recorded video 502. However, the rendering component(s) 108 may also begin to use the neural network(s) 120 to generate new frames 604(1)-(5) (also referred to singularly as “new frame 604” or in plural as “new frames 604”) representing the character interacting according to the speech. To generate the new frames 604, the rendering component(s) 108 may determine that the fifth frame 504(5) will be the last frame presented during the transition state, such as based on when the second period of time 602(2) ends. As such, the rendering component(s) 108 may use the sixth pose 506(6) associated with the sixth frame 504(6) to generate the first new frame 604(1). This way, the first new frame 604(1) may represent the character in the sixth pose 506(6). Additionally, the rendering component(s) 108 may use similar processes to then use the poses 506(7)-(10) associated with the frames 504(7)-(10) to respectively generate the new frames 604(7)-(10).

As such, during a third period of time 602(3), the rendering component(s) 108 may cause the presentation to operate in the interactive state. In the interactive state, the rendering component(s) 108 may cause the presentation of the new frames 604. By performing such processes, the pose of the character may remain accurate and/or smooth during the transition between the transition state and the interactive state. For example, even though the presentation moves from the fifth frame 504(5) of the recorded video 502 to the first new frame 604(1) generated by the rendering component(s) 108, the pose of the character may change from the fifth pose 506(5) associated with the fifth frame 504(5) to the sixth pose 506(6) associated with both the sixth frame 504(6) and the first new frame 604(1) which keeps the changes in the poses smooth.

Referring back to the example of FIG. 1, in some examples, the rendering component(s) 108 may continue to generate new frames while operating in the interactive state, such as if there is additional speech to be output by the character. Additionally, in some examples, the state component(s) 124 may cause the rendering component(s) 108 to transition the presentation from the interactive state to the idle state based on the occurrence of one or more events. For example, the state component(s) 124 may cause the transition based on there no longer being speech data 106 representing speech to be output, a period of time elapsing, the rendering component(s) 108 presenting all of the newly generated frames, and/or any other event occurring. Once transferred back to the idle state, the rendering component(s) 108 may then again cause presentation of the recorded video.

In some examples, such as to again ensure a smooth transition between the interactive state and the idle state, the pose identifier(s) 126 may determine which frame of the recorded video to begin with when making the transition to the idle state. For instance, the pose identifier(s) 126 may identify a frame that is subsequent to the last frame from the recorded video that is associated with the last pose used to generate a new frame. The rendering component(s) 108 may then start the playback of the recorded video starting at the identified frame of the recorded video. This way, the pose of the character remains accurate and/or smooth during the presentation of the frames even through the presentation transitions from using the newly generated frames to using the frames from the recorded video.

For instance, FIG. 6B illustrates an example of transitioning from operating in an interactive state to an idle state when presenting a character, in accordance with some embodiments of the present disclosure. As shown, during a fourth period of time 602(4), the rendering component(s) 108 may cause the presentation to operate in the interactive state. As such, the rendering component(s) 108 may continue using the neural network(s) 120 to generate new frames 606(6)-(10) using the poses 506(5)-(9) associated with the frames 504(5)-(9). For instance, since the rendering component(s) 108 is playing back in the reverse direction associated with the recorded video 502, the rendering component(s) 108 may generate the sixth new frame 606(6) using the ninth pose 506(9), the seventh new frame 606(7) using the eighth pose 506(8), the eighth new frame 606(8) using the seventh pose 506(7), and/or so forth. The rendering component(s) 108 may also continue the presentation using the new frames 606(6)-(10).

At the end of the fourth period of time 602(4), the rendering component(s) 108 may cause the presentation to transition from operating in the interactive state to operating in the idle state during a fifth period of time 602(5). As such, since the last new frame 604(10) presented during the interactive state was associated with the fifth pose 506(5), the rendering component(s) 108 may begin the idle state by presenting the fourth frame 504(4) associated with the recorded video 502. This way, the poses of the character remain accurate and/or smooth during the transition from the interactive state to the idle state. The rendering component(s) 108 may then continue the presentation using the frames 504 of the recorded video 502 until reaching the first frame 504(1) of the recorded video 502. At that point, the rendering component(s) 108 may start playing the recorded video 502 in the forward direction, where the rendering component(s) 108 causes the presentation of the second frame 504(2) of the recorded video 502.

Referring back to the example of FIG. 1, in some examples, the rendering component(s) 108 may use one or more additional and/or alternative techniques to ensure that the presentation of the character is accurate, smooth, and/or consistent. For instance, in some examples, the rendering component(s) 108 may separate a portion of the character-such as the head of the character, the mouth region of the character, and/or any other portion of the character -from the rest of the character. The rendering component(s) may then perform one or more of the processes described herein (e.g., using the neural network(s) 120) to render the separate portion of the character. Additionally, the rendering component(s) 108 may generate the frames of the character by overlapping (e.g., blending) the rendered portion of the character back onto a rendering of the rest of the character. This way, the rendering component(s) 108 may only need to create new renderings of the portion of the character without creating new renderings of the rest of the character.

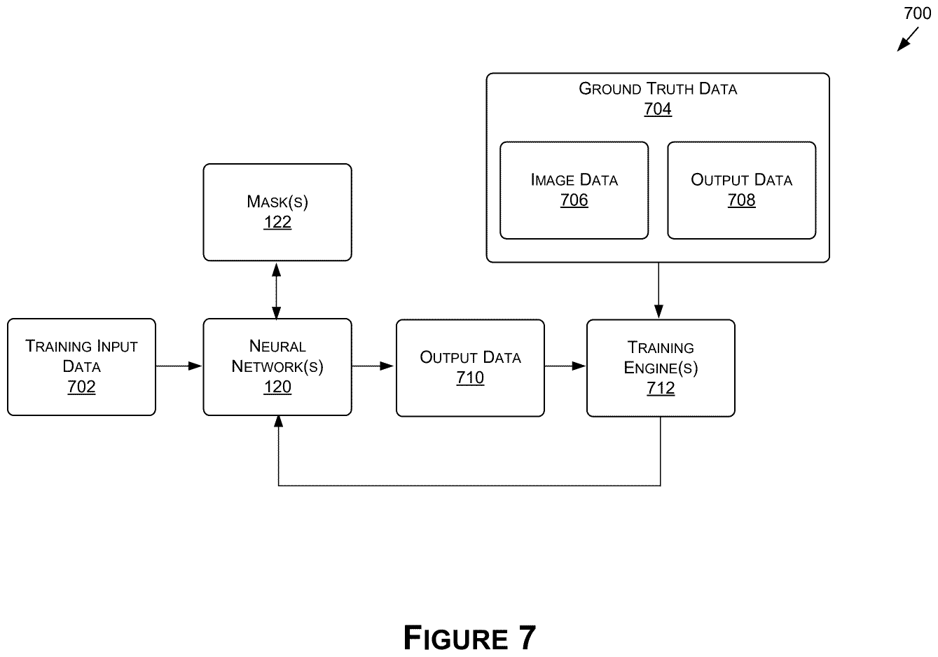

As described herein, in some examples, the neural network(s) 120 may be trained to perform one or more of the processes described herein. Additionally, in order to improve the training of the neural network(s) 120, the training may include using one or more of the masks 122 described herein. For instance, FIG. 7 illustrates an example data flow diagram for a process 700 of training the neural network(s) 120 to perform neural rendering of a character, in accordance with some embodiments of the present disclosure.

As shown, the neural network(s) 120 may be trained using training input data 702. As described herein, the training input data 702 may include, but is not limited to, pose data representing poses of a character that is depicted in a video represented by ground truth data 704 (e.g., poses of the head of the character for different frames of the video represented by the ground truth data 704), audio data representing speech being output by the character in the video, eye data representing values for eye movements of the character as depicted in the video (e.g., values for the eye movements of the different frames of the video), image data representing the video, and/or any other type of training data that may be input into the neural network(s) 120. In some examples, the training input data 702 may be real produced, synthetically produced, and/or any combination thereof.

The neural network(s) 120 may be trained using the training input data 702 along with the corresponding ground truth data 704. As shown, the ground truth data 704 may include, but is not limited to, image data 706 representing the video of the character speaking, output values 708 (e.g., color values, densities, etc.) associated with the video, and/or any other type of ground truth data. In some examples, the ground truth data 704 may be real produced, synthetically produced, and/or any combination thereof. Additionally, in some examples, for each instance of the training input data 702, there may be corresponding ground truth data 704. For example, for each pose, audio sample, and/or eye movement value that is input into the neural network(s) 120, there may be a corresponding image and/or set of output values that should be output using the neural network(s) 120.

To train the neural network(s) 120, the training input data 702 may be input into the neural network(s) 120 which may process the training input data 702 to generate output data 710. As described herein, in some examples, the neural network(s) 120 may include and/or use one or more of the mask(s) 122, such as the audio-attention mask 122 and/or the eye-attention mask 122, when processing the training input data 702 to generate the output data 710. Additionally, in some examples, the output data 710 may represent the colors and/or densities of points as determined by the neural network(s) 120 processing the training input data 702. Additionally, or alternatively, in some examples, the output data 710 may represent images that are generated using the colors and/or densities of the points as determined by the neural network(s) 120, such as by performing further processing (e.g., using the rendering component(s) 108).

In either of the examples, one or more training engines 712 may use one or more loss functions to measure one or more losses based on comparing the output data 710 to the ground truth data 704. For a first example, the training engine(s) 712 may use one or more loss functions that measure losses based on comparing images represented by the output data 710 to ground truth images represented by the ground truth data 704. For a second example, the training engine(s) 712 may use one or more loss functions to measure losses based on comparing point colors and/or densities represented by the output data 710 to ground truth point colors and/or densities represented by the ground truth data 704. In any of these examples, the training engine(s) 712 may then backpropagate the losses through the neural network(s) 120 to update the parameters and/or weights of the neural network(s) 120, which is indicated by the arrow from the training engine(s) 712 to the neural network(s) 120. For instance, in some examples, the training engine(s) 712 may update at least the audio-attention module and/or the eye-attention module based at least on the training.

While the example of FIG. 7 illustrates one example technique for training the neural network(s) 120, in other examples, the neural network(s) 120 may be trained using additional and/or alternative techniques. Additionally, in some examples, the neural network(s) 120 may be trained without using the mask(s) 122.

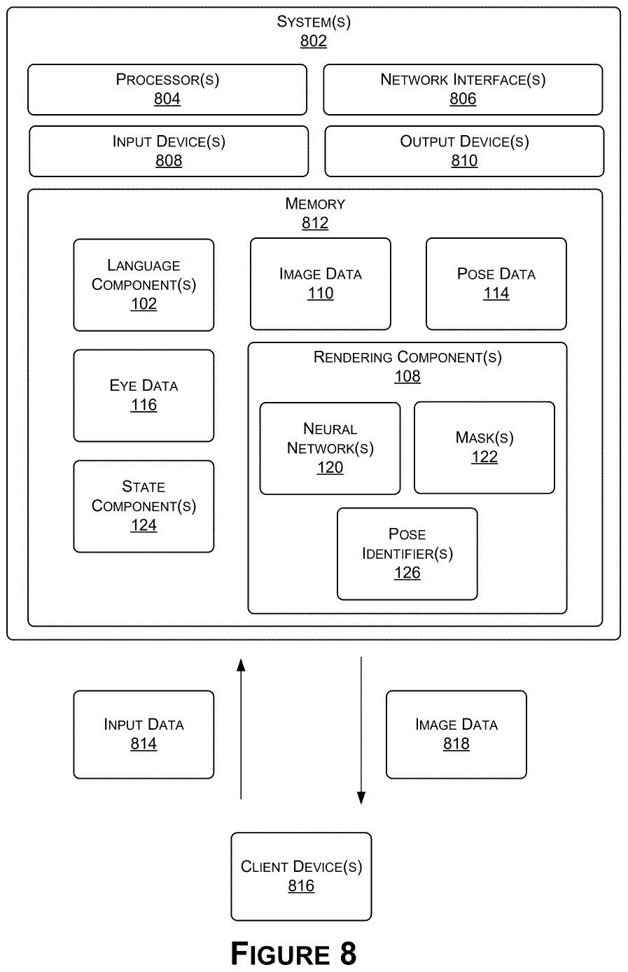

FIG. 8 illustrates an example of one or more systems 802 that may use one or more of the processes described herein to render and provide a character, in accordance with some embodiments of the present disclosure. As shown, the system(s) 802 may include one or more processors 804 (which may include, and/or be similar to, a CPU(s) 1306 and/or a GPU(s) 1308), one or more communication interfaces 806 (which may include, and/or be similar to, a communication interface 1310), one or more input devices 808, one or more output devices 810, and a memory 812 (which may include, and/or be similar to, a memory 1304). The input device(s) 808 may include, but is not limited to, one or more microphones, a keyboard, a controller, a joystick, a button, a touch-sensitive screen, and/or any other type of input device. Additionally, the output device(s) 810 may include, but is not limited to, a display, one or more speakers, and/or any other type of output device.

In some examples, the system(s) 802 may use the input device(s) 808 to receive input data, such as audio data representing user speech. Additionally, or alternatively, in some examples, the system(s) 802 may receive input data 814—such as audio data representing user speech—from one or more client devices 816. In either of the examples, the system(s) 802 may then perform one or more of the processes described herein to process the input data, such as by using at least the rendering component(s) 108, to generate image data 818 (which may include, and/or be similar to, the image data 118) representing frames depicting a character. Additionally, the system(s) 802 may provide the video that includes the frames to the user, such as by displaying the frames using the output device(s) 810 and/or sending the image data 818 to the client device(s) 816 for display of the video by the client device(s) 816. Additionally, the system(s) may cause audio representing the speech of the character to be output with the presentation of the frames.

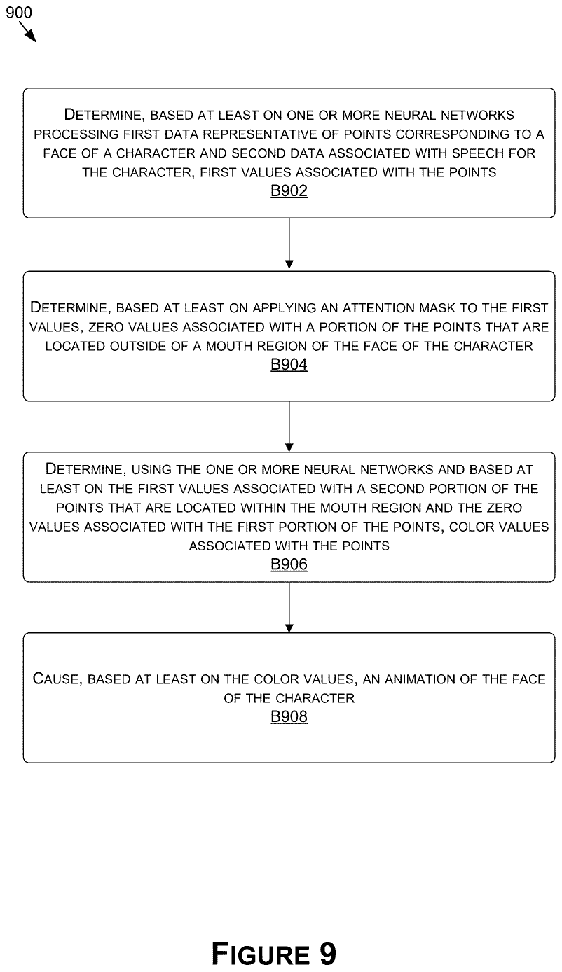

Now referring to FIGS. 9-12, each block of methods 900, 1000, 1100, and 1200, described herein, comprises a computing process that may be performed using any combination of hardware, firmware, and/or software. For instance, various functions may be carried out by a processor executing instructions stored in memory. The methods 900, 1000, 1100, and 1200 may also be embodied as computer-usable instructions stored on computer storage media. The methods 900, 1000, 1100, and 1200 may be provided by a standalone application, a service or hosted service (standalone or in combination with another hosted service), or a plug-in to another product, to name a few. In addition, these methods 900, 1000, 1100, and 1200 are described, by way of example, with respect to FIG. 1. However, these methods 900, 1000, 1100, and 1200 may additionally or alternatively be executed by any one system, or any combination of systems, including, but not limited to, those described herein.

FIG. 9 illustrates a flow diagram showing a method 900 for performing neural rendering using one or more attention masks, in accordance with some embodiments of the present disclosure. The method 900, at block B902, may include determining, based at least on one or more neural networks processing first data representing points corresponding to a face of a character and second data associated with speech for the character, first values associated with the points. For instance, the rendering component(s) 108 may use the neural network(s) 120 to process the pose data 114 representing the pose of the character, where the pose is associated with the points corresponding to the face of the character, and the speech data 106 associated with the speech. Based at least on the processing, the neural network(s) 120 may determine the first values associated with the points. As described herein, in some examples, the first values may be associated with how much the speech affects motion associated with the face.

The method 900, at block B904, may include determining, based at least on applying an attention mask to the first values, zero values associated with a portion of the points that are located outside of a mouth region of the face of the character. For instance, the rendering component(s) 108 and/or the neural network(s) 120 may apply the mask 122 to the first values of the points. As described herein, the mask 122 may be configured such that the first values associated with the points located outside of the mouth region of the character are reduced to zero while the first values associated with the points located within the mouth region of the character remain the same. This way, the audio input may not affect the motion associated with the region(s) of the face of the character that are outside of the mouth region.

The method 900, at block B906, may include determining, using the one or more neural networks and based at least on the first values associated with a second portion of the points that are located within the mouth region and the zero values associated with the first portion of the points, color values associated with the points. For instance, the neural network(s) 120 may then further process at least the first values associated with the points located within the mouth region of the character and the zero values associated with the points located outside of the mouth region of the character. Based at least on the processing, the neural network(s) 120 may determine the color values and/or densities associated with the points.

The method 900, at block B908, may include causing, based at least on the color values associated with the points, an animation of the face of the character. For instance, the rendering component(s) 108 may generate one or more frames representing the character using the color values. The rendering component(s) 108 may then output the image data 118 representing the frame(s) to one or more systems and/or one or more client devices that use the image data 118 to present the frame(s).

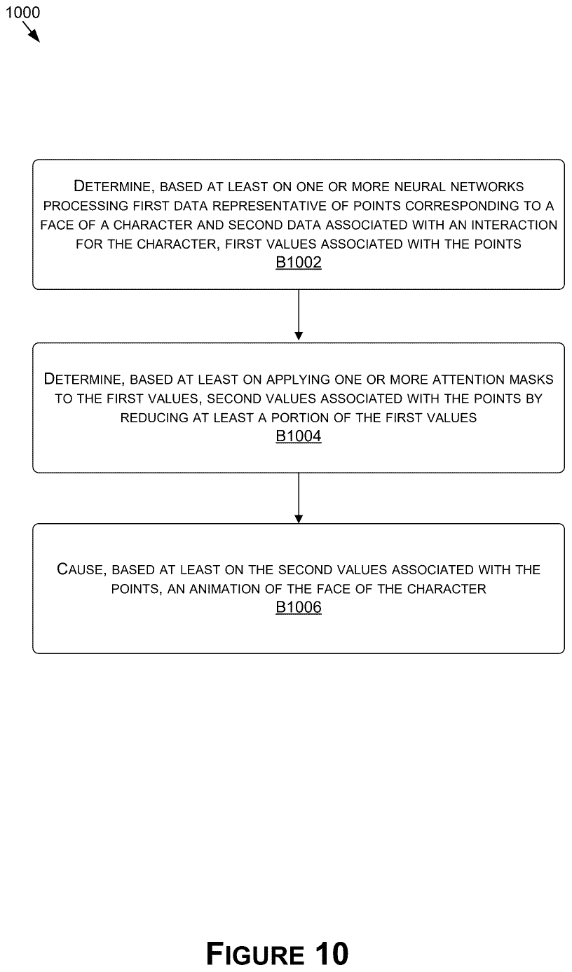

FIG. 10 illustrates a flow diagram showing another method 1000 for performing neural rendering using one or more attention masks, in accordance with some embodiments of the present disclosure. The method 1000, at block B1002, may include determining, using one or more neural networks and based at least on first data representing points corresponding to a face of a character and second data associated with an interaction for the character, first values associated with the points. For instance, the rendering component(s) 108 may use the neural network(s) 120 to process the pose data 114 representing the pose of the character, where the pose is associated with the points corresponding to the face of the character. Additionally, the neural network(s) 120 may process the speech data 106 associated with the speech and/or the eye data 116 associated with the eye movements of the character. Based at least on the processing, the neural network(s) 120 may determine the first values associated with the points. As described herein, in some examples, the first values may be associated with how much the speech and/or the eye movements affect motion associated with the face.

The method 1000, at block B1004, may include determining, based at least on applying one or more attention masks to the first values, second values associated with the points by at least reducing a portion of the first values. For instance, the rendering component(s) 108 and/or the neural network(s) 120 may apply the attention mask(s) 122 to the first values. As described herein, the attention mask(s) 122 may include an audio-attention mask 122, an eye-attention mask 122, and/or any other type of attention mask 122. Based at least on applying the attention mask(s) 122, at least the portion of the first values may be reduced, such as to zero values. For example, the audio-attention mask 122 may cause the first values associated with the points located outside of the mouth region of the face to reduce to zero and/or the eye-attention mask 122 may cause the first values associated with the points located outside of the eye regions of the face to reduce to zero.

The method 1000, at block B1006, may include causing, based at least on the second values associated with the points, an animation of the face of the character. For instance, the neural network(s) 120 may process at least the second values associated with the points to determine color values and/or densities associated with the points. The rendering component(s) 108 may then use the color values and/or the densities to generate one or more frames representing the character performing the interaction. Additionally, the rendering component(s) 108 may output the image data 118 representing the frame(s) to one or more systems and/or one or more client devices that use the image data 118 to present the frame(s).

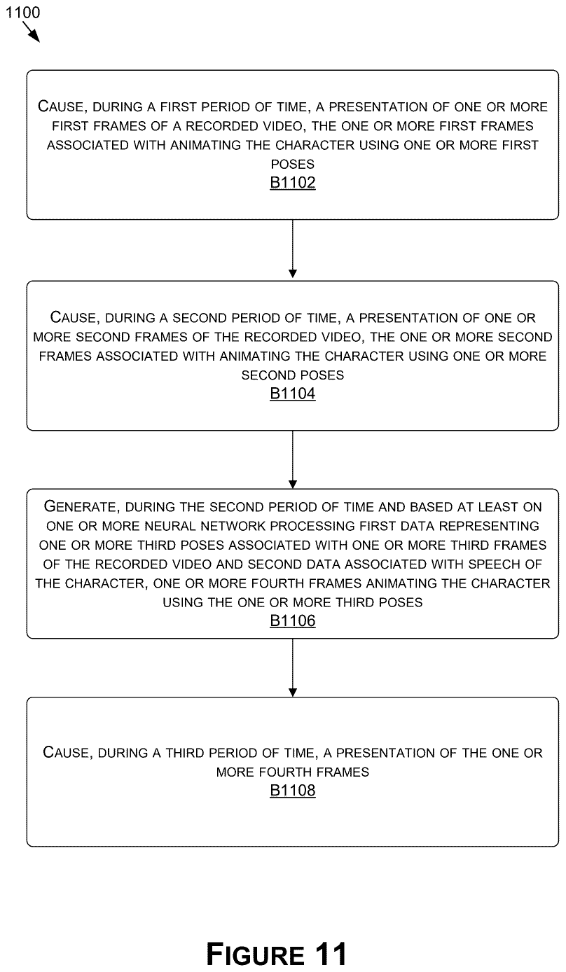

FIG. 11 illustrates a flow diagram showing a method 1100 for controlling a presentation of a character using various operating states, in accordance with some embodiments of the present disclosure. The method 1100, at block B1102, may include causing, during a first period of time, a presentation of one or more first frames of a recorded video, the one or more first frames associated with animating a character using one or more first poses. For instance, during the first period of time, the rendering component(s) 108 may cause at least the presentation of the first frame(s) of the recorded video, where the recorded video may be represented by the image data 110. As described herein, the first period of time may be associated with an idle state associated with the character. For example, the first frame(s) may represent the character as not interacting.

The method 1100, at block B1104, may include causing, during a second period of time, a presentation of one or more second frames of the recorded video, the one or more second frames associated with animating the character using one or more second poses. For instance, during the second period of time, the rendering component(s) 108 may cause at least the presentation of the second frame(s) of the recorded video, where the second frame(s) is subsequent to the first frame(s). As described herein, the second period of time may be associated with a transition state associated with the character. For example, the second frame(s) may still represent the character as not interacting. However, a user may begin attempting to interact with the character, such as through speech.

The method 1100, at block B1006, may include generating, during the second period of time and based at least on one or more neural networks processing first data representing one or more third poses associated with one or more third frames of the recorded video and second data associated with speech for the character, one or more fourth frames animating the character using the one or more third poses. For instance, during the second period of time, the pose identifier(s) 126 may determine the pose(s) associated with the third frame(s) of the recorded video, where the third frame(s) is subsequent to the second frame(s). The rendering component(s) 108 may then use the neural network(s) 120 so generate the fourth frame(s) based at least on the first data representing the pose(s) and the second data associated with the speech. For example, the fourth frame(s) may represent the character using the third pose(s) and as speaking.

The method 1100, at block B1108, may include causing, during the third period of time, a presentation of the one or more fourth frames. For instance, during the third period of time, the rendering component(s) 108 may cause at least the presentation of the fourth frame(s). As described herein, the third period of time may be associated with an interactive state associated with the character. Additionally, by performing such processes, the animation of the character may remain accurate and/or smooth while transitioning between the operating states.

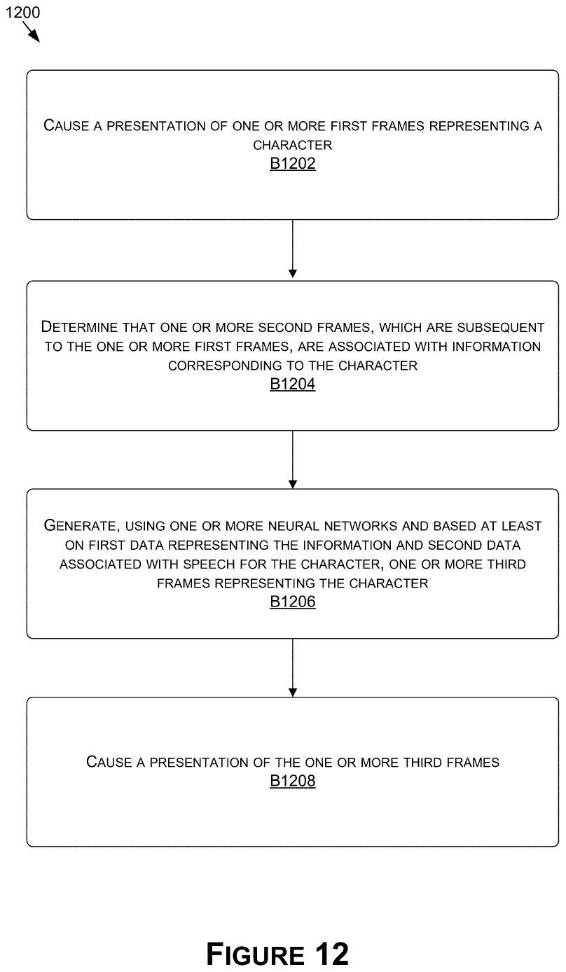

FIG. 12 illustrates a flow diagram showing another method 1200 for controlling a presentation of a character using various operating states, in accordance with some embodiments of the present disclosure. The method 1200, at block B1202, may include causing a presentation of one or more first frames representing a character. For instance, the rendering component(s) 108 may cause at least the presentation of the first frame(s) of a recorded video, where the recorded video may be represented by the image data 110. As described herein, the rendering component(s) 108 may cause the presentation of the first frame(s) during and idle state and/or a transition state associated with the character, where the first frame(s) may represent the character as not interacting.

The method 1200, at block B1204, may include determining that one or more second frames, which are subsequent to the one or more first frames, are associated with information corresponding to the character. For instance, the pose identifier(s) 126 may determine that the second frame(s) are subsequent to the first frame(s) in the recorded video. As such, the pose identifier(s) 126 may determine the information associated with the second frame(s). As described herein, the information may include one or more poses associated with the character, one or more values for eye movements associated with the character, and/or any other information associated with the character.

The method 1200, at block B1206, may include generating, using one or more neural networks and based at least on first data representing the information and second data associated with speech for the character, one or more third frames representing the character. For instance, the rendering component(s) 108 may use the neural network(s) 120 to generate the third frame(s) based at least on the first data representing the information and the second data associated with the speech. For example, the third frame(s) may represent the character using the same pose(s), eye movement(s), and/or the like associated with the information.

The method 1200, at block B1208, may include causing a presentation of the one or more third frames. For instance, the rendering component(s) 108 may cause at least the presentation of the third frame(s). As described herein, the rendering component(s) 108 may cause the presentation of the third frame(s) during an interactive state associated with the character, where the third frame(s) may represent the character as interacting.

### Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that enable the computing device 1300 to communicate with other computing devices via an electronic communication network, included wired and/or wireless communications. The communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may enable the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that enable detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to enable the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

### Example Data Center

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161(N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1433, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1433 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1433. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining, based at least on one or more neural networks processing first data representing three-dimensional (3D) points corresponding to a face of a character and second data associated with speech for the character, first values associated with the 3D points; determining, based at least on applying an attention mask to the first values, zero values associated with a first portion of the 3D points that are located outside of a mouth region corresponding to the face of the character; determining, using the one or more neural networks and based at least on the first values associated with a second portion of the 3D points that are located within the mouth region and the zero values associated with the first portion of the 3D points, color values associated with the 3D points; and causing, based at least on the color values associated with the 3D points, a rendering of an animation of at least the face of the character.
B: The method of paragraph A, wherein the attention mask indicates at least: a first weight to apply to the first values associated with the second portion of the 3D points that are located within the mouth region; and a second weight to apply to the first values associated with the first portion of the 3D points that are located outside of the mouth region.
C: The method of either paragraph A or paragraph B, wherein: the first portion of the 3D points are located within a first region of the face that is located outside of the mouth region; the method further comprises determining, based at least on applying the attention mask to the first values, zero values associated with a third portion of the 3D points that are located within a second region of the face, the second region of the face being located outside of the mouth region; and the determining the color values associated with the 3D points is further based at least on the zero values associated with the third portion of the 3D points.
D: The method of any one of paragraphs A-C, further comprising: determining, based at least on the one or more neural networks processing the first data and third data representing an eye movement corresponding to the face of the character, second values associated with the 3D points; and determining, based at least on applying a second attention mask to the second values, zero values associated with a third portion of the 3D points that are located outside of one or more eye regions corresponding to the face of the character, wherein the determining the color values associated with the 3D points is further based at least on the second values associated with a fourth portion of the 3D points that are located within the one or more eye regions and the zero values associated with the third portion of the 3D points.
E: The method of paragraph D, wherein the second attention mask indicates at least: a first weight to apply to the second values associated with the fourth portion of the 3D points that are located within the one or more eye regions; and a second weight to apply to the second values associated with the second portion of the 3D points that are located outside of the one or more eye regions.
F: The method of paragraph D, wherein the determining the color values associated with the 3D points comprises: determining third values associated with the 3D points based at least on the first values associated with the second portion of the 3D points, the zero values associated with the first portion of the 3D points, the second values associated with the fourth portion of the 3D points, and the zero values associated with the third portion of the 3D points; and determining, based at least on the one or more neural networks processing the third values, the color values associated with the 3D points.
G: The method of any one of paragraphs A-F, further comprising: receiving audio data representative of user speech; determining, based at least on one or more language models processing the audio data, a response to the user speech; and generating the second data associated with the speech corresponding to the response.
H: The method of any one of paragraphs A-G, further comprising causing an output of audio corresponding to the speech along with the animation of the face of the character.
I: A system comprising: one or more processors to: determine, using one or more neural networks and based at least on first data representing points corresponding to a face of a character and second data associated with speech for the character, first values associated with the points corresponding to the face of the character; determine, based at least on applying an attention mask to the first values, second values associated with the points by at least reducing a portion of the first values; and cause, based at least on the second values associated with the 3D points, a rendering of an animation of the face of the character.
J: The system of paragraph I, wherein the one or more processors are further to: determine, using the one or more neural networks and based at least on the first data and the second values, color values associated with the points, wherein the rendering of the animation of the face of the character is caused based at least on the color values associated with the points.
K: The system of either paragraph I or paragraph J, wherein the attention mask indicates: a third value to apply to a second portion of the first values that is associated with a mouth region of the face of the character; and a fourth value to apply to the portion of the first values that is associated with one or more other regions of the face of the character, the one or more other regions being outside of the mouth region.
L: The system of paragraph K, wherein: the portion of the first values is reduced to zero values; and the second values are further determined by at least maintaining a second portion of the first values.
M: The system of any one of paragraphs I-L, wherein the one or more processors are further to: determine, using the one or more neural networks and based at least on the first data and third data associated with an eye movement corresponding to the face of the character, third values associated with the points; and determine, based at least on applying a second attention mask to the third values, fourth values associated with the points by at least reducing a portion of the third values, wherein the rendering of the animation of the face of the character is further caused based at least on the fourth values.
N: The system of paragraph M, wherein the second attention mask indicates: a fifth value to apply to a second portion of the third values that is associated with one or more eye regions of the face of the character; and a sixth value to apply to the portion of the third values that is associated with one or more other regions of the face of the character, the one or more other regions being outside of the one or more eye regions.
O: The system of any one of paragraphs I-N, wherein the one or more processors are further to determine the first data representing the points corresponding to the face of the character based at least on a pose associated with the character.
P: The system of any one of paragraphs I-O, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems using or deploying one or more inference microservices; systems that incorporate one or more machine learning models deployed in a service or microservice along with an OS-level virtualization package (e.g., a container); a system incorporating one or more virtual machines (VMs); a system implemented at least partially in a data center; or a system implemented at least partially using cloud computing resources.
Q: One or more processors comprising: processing circuitry to: obtain input data representing one or more poses associated with a character and one or more interactions for the character; determine, using one or more neural networks that include one or more attention masks that reduce motion of the character outside of one or more facial regions and based at least on the input data, one or more frames representing the character using the one or more poses; and cause a rendering of an animation of the character using the one or more frames.
R: The one or more processors of paragraph Q, wherein the one or more attention masks include at least one of: a first attention mask that reduces first motion outside of a mouth region of the one or more facial regions, the first motion caused by a speech interaction of the one or more interactions; and a second attention mask that reduces second motion outside of one or more eye regions of the one or more facial regions, the second motion caused by a blinking interaction of the one or more interactions.
S: The one or more processors of either paragraph Q or paragraph R, wherein the determination of the one or more frames comprises: determining, based at least on the one or more neural network processing the input data, first values associated with points corresponding to a face of the character; determining, based at least on applying the one or more attention masks to the first values, second values associated with the points by at least reducing a portion of the first values that located outside of the one or more facial regions; and generating the one or more frames based at least on the second values.
T: The one or more processors of any one of paragraphs Q-S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems using or deploying one or more inference microservices; systems that incorporate one or more machine learning models deployed in a service or microservice along with an OS-level virtualization package (e.g., a container); a system incorporating one or more virtual machines (VMs); a system implemented at least partially in a data center; or a system implemented at least partially using cloud computing resources.
AA: A method comprising: causing, during a first period of time, a presentation of one or more first frames of a recorded video, the one or more first frames representing a character using one or more first poses; determining that one or more second frames of the recorded video, which are subsequent to the one or more first frames of the recorded video, are associated with one or more second poses for the character; generating, during at least a portion the first period of time and based at least on one or more neural networks processing first data representing the one or more second poses and second data associated with speech for the character, one or more third frames representing the character using the one or more second poses; and causing, during a second period of time, a presentation of the one or more third frames.
AB: The method of paragraph AA, wherein the one or more first frames include a plurality of frames of the recorded video and the causing the presentation of the plurality of frames of the recorded video comprises: causing, during a second portion of the first period of time that precedes the portion of the first period of time, a presentation a first portion of the plurality of frames, the second portion of the first period of time being associated with an idle state for the character; and based at least on receiving the second data, causing, during the portion of the first period of time, a presentation a second portion of the plurality of frames, the portion of the period of time being associated with a transition state for the character.
AC: The method of either paragraph AA or paragraph AB, further comprising: storing, during the at least the portion of the first period of time, image data representing at least a portion of the one or more third frames in one or more buffers, wherein the causing the presentation of the one or more third frames uses the image data stored in the one or more buffers and occurs at an elapse of the first period of time.
AD: The method of any one of paragraphs AA-AC, further comprising causing, during a third period of time, a presentation of one or more fourth frames of the recorded video, the one or more fourth frames being subsequent to the one or more second frames in the recorded video.
AE: The method of any one of paragraphs AA-AD, further comprising: determining that one or more fourth frames of the recorded video, which are subsequent to the one or more second frames of the recorded video, are associated with one or more third poses for the character; generating, during the second period of time and based at least on the one or more neural networks processing third data representing one or more third poses and fourth data associated with second speech for the character, one or more fifth frames representing the character using the one or more third poses; and causing, during a third period of time, a presentation of the one or more fifth frames.
AF: The method of any one of paragraphs AA-AE, further comprising: generating, during the second period of time and based at least on the one or more neural networks processing third data representing the one or more first poses and fourth data associated with second speech for the character, one or more fourth frames representing the character using the one or more first poses; and causing, during a third period of time, a presentation of the one or more fourth frames.
AG: The method of any one of paragraphs AA-AF, further comprising: generating, based at least on the one or more neural networks processing third data representing at least the one or more first poses and the one or more second poses associated with the character, image data representing the recorded video; and storing the image data in one or more memories.
AH: A system comprising: one or more processors to: cause a presentation of one or more first frames representing a character; determine that one or more second frames, which are subsequent to the one or more first frames, are associated with one or more poses of the character; generate, using one or more neural networks and based at least on first data representing the one or more poses and second data associated with speech for the character, one or more third frames representing the character using the one or more poses; and cause a presentation of the one or more third frames.
AI: The system of paragraph AH, wherein: the one or more first frames are associated with a recorded video; the one or more processors are further to identify the one or more second frames as being subsequent to the one or more first frames in the recorded video; and the one or more third frames are generated during the presentation of the one or more first frames.
AJ: The system of either paragraph AH or paragraph AI, wherein the one or more processors are further to: cause, during a first period of time associated with a first state of the character, a presentation of one or more fourth frames of a recorded video, the one or more fourth frames representing the character, wherein: the presentation of the one or more first frames of the recorded video is caused during a second period of time that is associated with a second state of the character; the one or more third frames are generated during the second period of time; and the presentation of the one or more third frames is caused during a third period of time that is associated with a third state of the character.
AK: The system of any one of paragraphs AH-AJ, further comprising: obtain the second data associated with the speech, wherein the determination that the one or more second poses are associated with the one or more poses for the character is based at least on the second data associated with the speech for the character being obtained.
AL: The system of any one of paragraphs AH-AK, wherein: the one or more second frames are subsequent to the one or more first frames in recorded video; and the one or more processors are further to cause, after the presentation of the one or more third frames, a presentation of one or more fourth frames of the recorded video that are subsequent to the one or more second frames, the one or more fourth frames representing the character.
AM: The system of any one of paragraphs AH-AL, wherein the one or more processors are further to: determine that one or more fourth frames, which are subsequent to the one or more second frames, are associated with one or more second poses; during the presentation of the one or more third frames, generate, using the one or more neural networks and based at least on third data representing the one or more second poses and fourth data associated with second speech for the character, one or more fifth frames representing the character in the one or more second poses; and cause a presentation of the one or more fifth frames.
AN: The system of any one of paragraphs AH-AM, wherein the one or more processors are further to: determine that the one or more first frames are associated with one or more second poses; during the presentation of the one or more third frames, generate, using the one or more neural networks and based at least on third data representing the one or more second poses and fourth data associated with second speech for the character, one or more fourth frames representing the character in the one or more second poses; and cause a presentation of the one or more fifth frames.
AO: The system of any one of paragraphs AH-AN, wherein the one or more processors are further to: generate, using the one or more neural networks and based at least on third data representing at least one or more poses, image data representing the one or more first frames and the one or more second frames; and store the image data in one or more memories, wherein the presentation of the one or more first frames is caused using at least a portion of the image data stored in the one or more memories.
AP: The system of any one of paragraphs AH-AO, wherein: the one or more first frames represent the character as refraining from interacting; the one or more second frames represent the character as refraining from interacting; and the one or more third frames representing the character interacting based at least on the speech.
AQ: The system of any one of paragraphs AH-AP, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems using or deploying one or more inference microservices; systems that incorporate one or more machine learning models deployed in a service or microservice along with an OS-level virtualization package (e.g., a container); a system incorporating one or more virtual machines (VMs); a system implemented at least partially in a data center; or a system implemented at least partially using cloud computing resources.
AR: One or more processors comprising: processing circuitry to: cause a presentation of one or more first frames representing a character; determine that one or more second frames, which are subsequent to the one or more first frames, are associated with information corresponding to the character; generate, using one or more neural networks and based at least on first data representing the information and second data associated with speech for the character, one or more third frames representing the character; and cause a presentation of the one or more third frames.
AS: The one or more processors of paragraph AR, wherein the one or more processors are further to: determine a time period associated with the presentation of the one or more first frames; and determining the one or more second frames based at least on the period of time.
AT: The one or more processors of either paragraph AR or paragraph AS, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems using or deploying one or more inference microservices; systems that incorporate one or more machine learning models deployed in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
determining, based at least on one or more neural networks processing first data representing three-dimensional (3D) points corresponding to a face of a character and second data associated with speech for the character, first values associated with the 3D points;
determining, based at least on applying an attention mask to the first values, zero values associated with a first portion of the 3D points that are located outside of a mouth region corresponding to the face of the character;
determining, using the one or more neural networks and based at least on the first values associated with a second portion of the 3D points that are located within the mouth region and the zero values associated with the first portion of the 3D points, color values associated with the 3D points; and
causing, based at least on the color values associated with the 3D points, a rendering of an animation of at least the face of the character.

2. The method of claim 1, wherein the attention mask indicates at least:
a first weight to apply to the first values associated with the second portion of the 3D points that are located within the mouth region; and
a second weight to apply to the first values associated with the first portion of the 3D points that are located outside of the mouth region.

3. The method of claim 1, wherein:
the first portion of the 3D points are located within a first region of the face that is located outside of the mouth region;
the method further comprises determining, based at least on applying the attention mask to the first values, zero values associated with a third portion of the 3D points that are located within a second region of the face, the second region of the face being located outside of the mouth region; and
the determining the color values associated with the 3D points is further based at least on the zero values associated with the third portion of the 3D points.

4. The method of claim 1, further comprising:
determining, based at least on the one or more neural networks processing the first data and third data representing an eye movement corresponding to the face of the character, second values associated with the 3D points; and
determining, based at least on applying a second attention mask to the second values, zero values associated with a third portion of the 3D points that are located outside of one or more eye regions corresponding to the face of the character,
wherein the determining the color values associated with the 3D points is further based at least on the second values associated with a fourth portion of the 3D points that are located within the one or more eye regions and the zero values associated with the third portion of the 3D points.

5. The method of claim 4, wherein the second attention mask indicates at least:
a first weight to apply to the second values associated with the fourth portion of the 3D points that are located within the one or more eye regions; and
a second weight to apply to the second values associated with the second portion of the 3D points that are located outside of the one or more eye regions.

6. The method of claim 4, wherein the determining the color values associated with the 3D points comprises:
determining third values associated with the 3D points based at least on the first values associated with the second portion of the 3D points, the zero values associated with the first portion of the 3D points, the second values associated with the fourth portion of the 3D points, and the zero values associated with the third portion of the 3D points; and
determining, based at least on the one or more neural networks processing the third values, the color values associated with the 3D points.

7. The method of claim 1, further comprising:
receiving audio data representative of user speech;
determining, based at least on one or more language models processing the audio data, a response to the user speech; and
generating the second data associated with the speech corresponding to the response.

8. The method of claim 1, further comprising causing an output of audio corresponding to the speech along with the animation of the face of the character.

9. A system comprising:
one or more processors to:
determine, using one or more neural networks and based at least on first data representing points corresponding to a face of a character and second data associated with speech for the character, first values associated with the points corresponding to the face of the character;
determine, based at least on applying an attention mask to the first values, second values associated with the points by at least reducing a portion of the first values; and
cause, based at least on the second values associated with the 3D points, a rendering of an animation of the face of the character.

10. The system of claim 9, wherein the one or more processors are further to:
determine, using the one or more neural networks and based at least on the first data and the second values, color values associated with the points,
wherein the rendering of the animation of the face of the character is caused based at least on the color values associated with the points.

11. The system of claim 9, wherein the attention mask indicates:
a third value to apply to a second portion of the first values that is associated with a mouth region of the face of the character; and
a fourth value to apply to the portion of the first values that is associated with one or more other regions of the face of the character, the one or more other regions being outside of the mouth region.

12. The system of claim 11, wherein:
the portion of the first values is reduced to zero values; and
the second values are further determined by at least maintaining a second portion of the first values.

13. The system of claim 9, wherein the one or more processors are further to:
determine, using the one or more neural networks and based at least on the first data and third data associated with an eye movement corresponding to the face of the character, third values associated with the points; and
determine, based at least on applying a second attention mask to the third values, fourth values associated with the points by at least reducing a portion of the third values,
wherein the rendering of the animation of the face of the character is further caused based at least on the fourth values.

14. The system of claim 13, wherein the second attention mask indicates:
a fifth value to apply to a second portion of the third values that is associated with one or more eye regions of the face of the character; and
a sixth value to apply to the portion of the third values that is associated with one or more other regions of the face of the character, the one or more other regions being outside of the one or more eye regions.

15. The system of claim 9, wherein the one or more processors are further to determine the first data representing the points corresponding to the face of the character based at least on a pose associated with the character.

16. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems using or deploying one or more inference microservices;
systems that incorporate one or more machine learning models deployed in a service or microservice along with an OS-level virtualization package (e.g., a container);
a system incorporating one or more virtual machines (VMs);
a system implemented at least partially in a data center; or
a system implemented at least partially using cloud computing resources.

17. One or more processors comprising:
processing circuitry to:
obtain input data representing one or more poses associated with a character and one or more interactions for the character;
determine, using one or more neural networks that include one or more attention masks that reduce motion of the character outside of one or more facial regions and based at least on the input data, one or more frames representing the character using the one or more poses; and
cause a rendering of an animation of the character using the one or more frames.

18. The one or more processors of claim 17, wherein the one or more attention masks include at least one of:
a first attention mask that reduces first motion outside of a mouth region of the one or more facial regions, the first motion caused by a speech interaction of the one or more interactions; and
a second attention mask that reduces second motion outside of one or more eye regions of the one or more facial regions, the second motion caused by a blinking interaction of the one or more interactions.

19. The one or more processors of claim 17, wherein the determination of the one or more frames comprises:
determining, based at least on the one or more neural network processing the input data, first values associated with points corresponding to a face of the character;
determining, based at least on applying the one or more attention masks to the first values, second values associated with the points by at least reducing a portion of the first values that located outside of the one or more facial regions; and
generating the one or more frames based at least on the second values.

20. The one or more processors of claim 17, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems using or deploying one or more inference microservices;
systems that incorporate one or more machine learning models deployed in a service or microservice along with an OS-level virtualization package (e.g., a container);
a system incorporating one or more virtual machines (VMs);
a system implemented at least partially in a data center; or
a system implemented at least partially using cloud computing resources.
